(19) United States
(12) Patent Application Publication
(10) Pub. No.: US 2002/0085765 A1
(43) Pub. Date: Jul. 4, 2002

(54) Dual mode data compression technique Dual mode data compression technique

(76) Inventor: Thomas P. Brady, Methuen, MA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/750,293

(22) Filed: Dec. 29, 2000

(51) Int. Cl. G06K 9/36; G06K 9/46

(52) U.S. Cl. 382/239

(57) ABSTRACT

An encoder for compressing image information includes a memory and processor. The memory stores a sequence of characters representing an image. The processor determines if the stored sequence of characters corresponds to a banded image or a page image. The processor operates in a first mode if the stored sequence of characters is determined to correspond to the banded image. The processor operates in a second mode, different than the first mode, if the stored sequence of characters is determined to correspond to the page image.

### RELATED APPLICATIONS

This application is related to U.S. application Ser. No. ______,(Attorney Docket: 3175-51), entitled “Enhanced Data Compression Technique” and filed concurrently herewith on Dec. 29, 2000.

### TECHNICAL FIELD

The present application relates generally to data compression and more particularly to an enhanced data compression technique particularly suitable for use in the graphical arts for compressing large images.

### BACKGROUND ART

In the graphic arts there is a tendency to have extremely large, one-bit-per-sample images approaching or even exceeding 2 gigabytes of data. The need to compress such data has been well known for many years.

One proposed technique for compressing such data is commonly referred to as a pack-bit (PB) compression technique. Using proposed PB compression techniques, either a string of characters is preceded with a count and a repeat character code or a single byte pattern is preceded with a count. Proposed PB compression techniques are capable of processing data very quickly. These techniques also provide satisfactory results if the data is either solid black or solid white, and hence digitally represented in binary form by all 1's or 0's. Accordingly, PB techniques provide reasonably satisfactory results for non-color image data.

An exemplary pack-bits representation of a stream of sequential input data, as it would appear entering a processor prior to encoding, might include the string of characters “abc0000000000”. Using the PB technique, the processor would first determined whether or not the first character “a” and the second character “b” match. Under some proposed PB techniques, the processor might scan ahead to consider other matches in certain of the subsequent characters. In any event, since in the present example the determination is negative, the processor proceeds to encode the input data as a literal string with a length. The processor next determines whether or not the second character “b” and the third character “c” match. Since this determination is also negative, the processor will proceed to encode the three characters of the input data as a literal string with a length. The processor now determines whether or not the third character “c” and the fourth character “0” match. Since this determination is also negative, the processor will proceed to encode the four characters of the input data as a literal string with a length. The processor continues by determining whether or not the fourth character “0” and the fifth character “0” match. Since this determination is positive, the processor continues by determining whether or not the immediately subsequent characters in the sequence also match, until it makes a negative determination. The processor thereby determines the repeat count for the character “0”. Based on the initial positive determination, the processor also proceeds to encode the first three characters of the input data sequence, i.e. “a”,“b” and “c”, as a literal string with a length and the following 10 characters of the input data sequence, i.e. the “0”. . . “0”, as a repeat character with a count.

Accordingly, the processor generates encoded output data forming a 2-byte sequence including the strings of characters “82abc” and “090”. In the output data, the “8” serves as a header and indicates that the total length of the sequence is 8 bits and a literal string follows, the “2” indicates that the length of the literal string is three characters, i.e. characters “a”, “b”, and “c”, the first “0” indicates a repeat character follows, and the “9” indicates that the repeat character represented by the second “0” is repeated 10 times.

To decode the encoded sequence “82abc090”, the receiving processor first reads the new header “8”, which is the highest order bit, and from the header determines that a literal string follows. The processor then extracts the length “2” and reads the next three characters “a”, “b” and “c”. The processor next reads the first “O” and from this determines that a repeat character follows. The processor continues by extracting the count “9” and reading the next character “0”, which is the character to be repeated 10 times. It will be recognized that by using one-off numbers such as the “2” to indicate a literal string of 3 characters and the “9” to indicate that a repeat character is repeated 10 times, a close to 1% improvement is obtainable because 128 bytes can be packed into 129.

As should be clear from the above, PB techniques process only one character at a time. Accordingly, PB techniques are incapable of compressing strings of repeating multiple byte patterns. PB techniques also have a relatively limited compression rate, generally no more than 64 to 1. Thus, PB compression techniques provide unsatisfactory results when used to compress color image data.

Another proposed technique for compressing image data is commonly referred to as the Lempel-Ziv-Welch (LZW) compression technique. Using proposed LZW compression techniques variable length of strings of byte based data can be processed. Proposed LZW compression technique, process the data somewhat slower than PB compression techniques, but provide satisfactory results on data representing color images as well as black and white images. However, since these techniques are based on single bytes of data, such techniques are incapable of compressing data on an arbitrary pixel or bit boundary basis. Additionally, although such techniques, are capable of providing a higher compression rate than PB compression techniques, LZW techniques still offer a somewhat limited compression rate.

An exemplary LZW representation of a stream of sequential input data, as it would appear entering a processor prior to encoding, might include the string of characters “abcOlcOl”. Using the LZW technique, the encoding and decoding processors must coordinate on the transmission and receipt of codes. LZW techniques use a compression dictionary containing some limited number of compression codes defined during the processing of the input data. The characters in the input string are read on a character by character basis to determine if a sub-string of characters match a compression code defined during the processing of prior characters in the input string. If so, the matching sub-string of characters are encoded with the applicable compression code. If a sub-string of characters does not match a pre-existing code, a new code corresponding to the sub-string is added to the dictionary. Sub-strings are initially defined by codes having 9 bits or digits, but the number of bits may be increased up to 12 bits to add new codes. Once the 12 bit limit is exceeded, the dictionary is reset and subsequent codes are again defined initially with 9 bits. In conventional LZW techniques, two codes are predefined, i.e. defined prior to initiating processing of the input string. In the present example these codes are the code 100, representing a reset, and the code 101, representing an end. In the present example, codes 102, 103, and 104 etc. represent strings of new patterns which are identified during the processing of the input data.

Using the LZW technique, the encoding processor would first read the “a” in the sequence and the “b” immediately thereafter in the sequence. The processor then determines if a code exists for the character sequence “ab”. Since, in this example, no such code exists at this point in the processing, a new code 103 is generated to represent the new pattern string “ab”. The processor continues by reading the “c” immediately following the “b” in the sequence. The processor determines if a code exists for the character sequence “bc”. Since, in this example, no such code exists at this point in the processing, a new code 104 is generated to represent the new pattern string “bc”.

The processor continues by reading the “0” immediately following the “c” in the sequence. The processor determines if a code exists for the character sequence “c0”. Since, in this example, no such code exists at this point in the processing, a new code 105 is generated to represent the new pattern string “c0”. The processor continues further by reading the “1” immediately following the “0” in the sequence. The processor determines if a code exists for the character sequence “01”. Since, in this example, no such code exist at this point in the processing, a new code 106 is generated to represent the new pattern string “01”. The processor proceeds by reading the “c” immediately following the “1” in the sequence. The processor determines if a code exists for the character sequence “1c”. Since, in this example, no such code exists at this point in the processing, a new code 107 is generated to represent the new pattern string “1c”.

The processor proceeds by reading the “0” immediately following the second “c” in the sequence. The processor determines if a code exists for the character sequence “c0”. In this example, such a code, i.e. code 105, does exist. The processor therefore proceeds by reading the “1” immediately following the second “c0” in the sequence. The processor determines if a code exists for the character sequence “c01”. Since, in this example, such a code does not exist, a new code 108 is generated to represent the new pattern string “c01” which can be represented as “1051”. The processor ultimately generates encoded output data forming a sequence including the string of characters “100abc01c105”.

Using the LZW technique, the encoding processor builds a tree of codes generated using other codes. This is a primary reason why the LZW techniques provide satisfactory results even though processing is performed on a byte by byte basis to find repeating bytes. That is, the downstream encoding builds on the upstream encoding. However, using the LZW technique, the encoding processor can take significant processing time to encode large sequences. For example, if there is a large, say a megabyte, occurrence of adjacent 0's or 1's, a significant period of time will be required by the processor to encode the sequence.

The decoding processor builds a similar tree from the codes received from the encoding processor. Basically, the decoding processor performs the reciprocal of the encoding process to decode the encoded sequence characters “100abc011051”.

In summary, the PB compression technique is deficient in that it addresses only single byte repeats and is limited to a 64 to 1 compression rate. Therefore, it is not suitable for color images. On the other hand, the LZW compression technique addresses multi-byte repeats and has a compression rate of perhaps 500 to 1, but requires significant processing time to build the codes which are required to obtain good compression. Hence, although the LZW technique may be suitable where relatively small amounts of data are involved, where the encoding of gigabytes of data is required, such as with an 80 inch×50 inch image having 2400 dots per inch, the processing time and/or resources to encode data using the LZW technique make the technique impractical.

Accordingly, a need exist for a technique which can quickly compress large amounts of image data, offer a still higher compression rate than previously proposed techniques, and provide satisfactory results when used to compress either color or non-color image data.

### OBJECTIVES OF THE INVENTION

It is an object of the present invention to provide a technique for quickly compressing large amounts of image data.

It is a further object of the present invention to provide a technique which facilitates high compression rates for either color or non-color image data.

It is yet another object of the present invention to provide a technique which gives satisfactory results when used to compress either color or non-color image data. Additional objects, advantages, novel features of the present invention will become apparent to those skilled in the art from this disclosure, including the following detailed description, as well as by practice of the invention. While the invention is described below with reference to preferred embodiment(s), it should be understood that the invention is not limited thereto. Those of ordinary skill in the art having access to the teachings herein will recognize additional implementations, modifications, and embodiments, as well as other fields of use, which are within the scope of the invention as disclosed and claimed herein and with respect to which the invention could be of significant utility.

### SUMMARY DISCLOSURE OF THE INVENTION

According to the present invention, an encoder for compressing image information includes a memory and processor. The memory is configured to store a sequence of characters representing an image. The processor is configured to determine if the stored sequence of characters corresponds to a banded image, such as a segment or slice across the entire image, or a page image, such as one of multiple separate images making up the entire image. The processor operates in a first mode to encode the stored sequence of characters, if the stored sequence of characters is determined to correspond to the banded image. The processor operates in a second mode, different than the first mode, to encode the stored sequence of characters, if the stored sequence of characters is determined to correspond to the page image.

Preferably, the processor encodes the stored sequence of characters in accordance with a pack-bit compression technique in the first mode of operation and in accordance with an LZW compression technique in the second mode of operation. Beneficially, the processor is also configured to encode the stored sequence of characters in accordance with a pack-bit compression technique in the second mode of operation, as this can be beneficial in some cases.

Advantageously, if the stored sequence of characters is determined to correspond to the page image, the processor is further configured to determine if the stored sequence of characters corresponds to a primarily white page image or a primarily black page image, which might be the case for a template type page image. If so, the processor encodes the stored sequence of characters in accordance with a first compression technique, e.g. a pack-bit compression technique, while operating in the second mode of operation. If not, the processor encodes the stored first sequence of characters in accordance with a second compression technique, different than the first compression technique, e.g. an LZW compression technique, while operating in the second mode of operation.

In one practical implementation, an imaging system may include a raster image processor which determines if a sequence of characters corresponds to a banded image or a page image. The raster image processor then operates in a first mode to encode the sequence of characters if the sequence of characters is determined to correspond to the banded image, and to operate in a second mode, different than the first mode, to encode the sequence of characters if the sequence of characters is determined to correspond to the page image.

An imager controller receives the encoded sequence of characters. The image controller then operates in either a first mode or second mode to decode the received encoded sequence of characters back into the unencoded sequence of characters. More particularly, the controller operates in a first mode if the encoded sequence of characters corresponds to the banded image, and in a second mode if the encoded sequence of characters corresponds to the page image.

Preferably, the raster image processor encodes the sequence of characters in accordance with a pack-bit compression technique in the first mode of operation, and in accordance with an LZW compression technique in the second mode of operation. Beneficially, the raster image processor is also capable of encoding the sequence of characters in accordance with a pack-bit compression technique in the second mode of operation.

In accordance with other aspects of the invention, if the first sequence of characters is determined to correspond to the page image, the raster image processor determines if the sequence of characters corresponds to a primarily white page image or a primarily black page image. If so, the raster image processor encodes the sequence of characters in accordance with a first compression technique, such as a pack-bit technique, while operating in the second mode of operation. If not, the raster image processor encodes the sequence of characters in accordance with a second compression technique which is different than the first compression technique, such as a LZW technique, while operating in the second mode of operation.

### BRIEF DESCRIPTION OF DRAWINGS

FIG. 1 depicts an exemplary simplifies depiction of an image processing system in accordance with a first embodiment of the present invention.

FIG. 2 depicts an exemplary simplifies depiction of an image processing system in accordance with a second embodiment of the present invention.

FIG. 3 depicts an exemplary code dictionary in accordance with the second embodiment of the present invention.

### BEST MODE FOR CARRYING OUT THE INVENTION

In pre-press imaging, particularly for the flats having an entire plate worth of image information, most of the data is often either solid black or solid white, and hence digitally represented in binary form by all 1's or 0's. For halftone images all of the data is black and white.

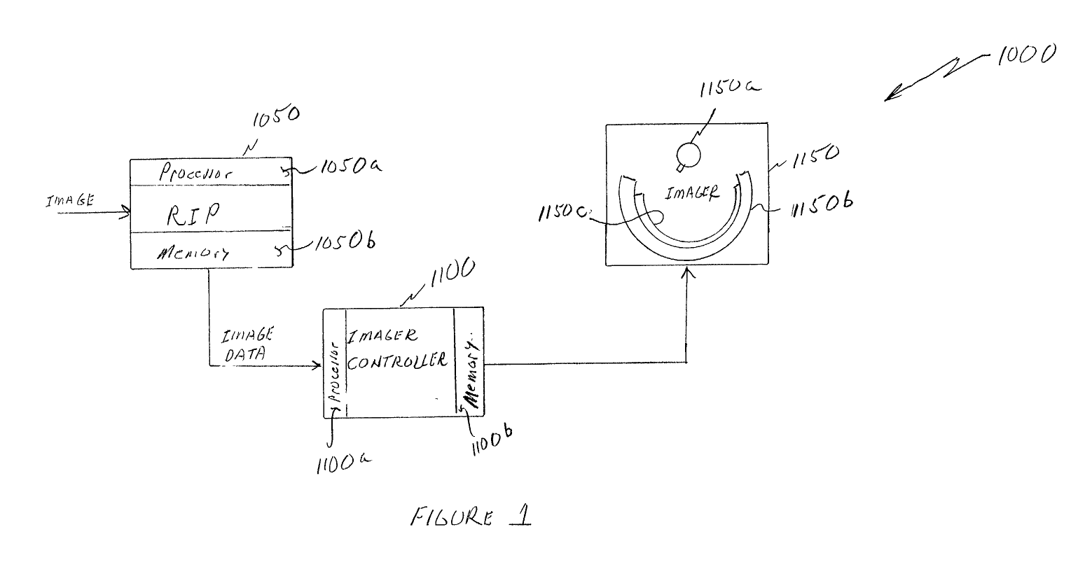

FIG. 1 is a somewhat simplified, exemplary depiction of a image processing system 1000 according to a first embodiment of the present invention. The system 1000 includes a raster image processor (RIP) 1050, which includes a processor 1050a and a memory 1050b for storing processing instructions and other data as required. The RIP 1050 receives image data and converts the image data into encoded data. The image data is then transmitted to an imager control processor 1100, which includes a processor 1000a and a memory 1100b for storing processing instructions and other data as required. The controller 1100 generates control signals to the imager 1150 in accordance with the data received from the RIP 1050, to control the imager 1150. More particularly, the control signals from the processor 1100a control the operation of the imager scanning assembly 1150a so as to form the image on a medium 1150c, such as a film or plate, supported within the imager 1150. As shown, the imager includes a cylindrical drum 1150b for supporting the medium 1150c, but could alternatively include a flat bed or external drum for supporting the medium.

In a first mode of operation, which will hereafter be referred to as a flat banding mode, the RIP 1050 receives an 80 inch×50 inch color separated image having 2400 dots per inch. Preferably using imposition software on a front end preprocessor (not shown), the image could, for example, correspond to multiple pages of a magazine. In such a case, the image is formatted such that the image printed from the imaged medium 1150c is positioned so as to facilitate cutting, folding and stitching to create multiple properly printed and positioned magazine pages. In any event, the RIP 1050 converts the entire image into multiple gigabytes of encoded data as a single job.

However, due to processing power limitations of RIP 1050, the entire image cannot be converted into encoded data in a single operational process. Accordingly, the image is sliced into bands, prior to being converted, typically by the RIP 1050. If converted by the RIP 1050, this banding of the image may be performed by the RIP processor 1050a. However, conversion could also be preformed outside the RIP, for example by a preprocessor (not shown). In the preferred embodiment, the RIP processor 1050a converts the image data representing each of the bands into encoded data in a separate operational process. Thus, the job is completed only after the multiple separate operational processes are performed by the RIP 1050 so as to convert all of the image data representing the bands for the entire image into encoded data. In practice, the larger the image the smaller is each image band, with all band preferably being equal in size. Furthermore, the larger the image the greater the startup time required before beginning the conversion of the image data to encoded data, because the larger the image, the more pre-conversion processing required. Additionally, the more objects included in the image, the more memory that is required.

In a second mode of operation, sometimes referred to as a page assembly mode, the RIP 1050 receives, as multiple images, an 80 inch×50 inch color image having 2400 dots per inch. In this case, one of the multiple images, which might be characterized as a template image, includes information such as registration marks, color gradients, and identification marks, but is primarily white. Each of the other of the multiple images could, for example, be the image for a separate page of a magazine. Here, the RIP 1050 may be operated to convert the image data representing the entire template image into encoded data as one job and to convert all of image data representing the other of the multiple images into image data in another job. When fully converted, the multiple images will be represented by encoded data.

More particularly, in the page assembly mode, the image is divided into page assemblies, one of which is a primarily white template image which is typically processed by the RIP processor 1050a without being split into bands. The other of the multiple images are, however, typically sliced into bands prior to being encoded by the RIP 1050. Because the area of each of the other multiple images is much smaller than the area of the entire image discussed with reference to the first mode of operation, fewer bands are required and, as a whole, it will take less time to convert the image data representing the multiple images into encoded data in the page assembly mode than the time required to convert the image data representing entire image into image data in the banding mode discussed above. Thus, the RIP processor 1050a converts the image data for each of the bands for each of the other multiple images into encoded data in a separate operational process. The job, or jobs if the template image is pre-processed, is completed only after the multiple operational processes are performed to convert all of the image data representing the multiple images forming the entire image into encoded data.

Although, the image discussed with reference to the page assembly mode may be the same as the image discussed with reference to the prior page assembly mode, conversion in the page assembly mode will typically result in even a greater amount of encoded data than the conversion in the previously discussed banding mode. For example, two gigabytes of encoded data may be generated by the RIP 1050 to represent the image in the banding mode, while three gigabytes of image data could be generated by the RIP 1050 to represent the same image in the page assembly mode because there would be more uncompressed data. Further, whether the banding or page assembly modes are utilized by the RIP 1050, the entire image cannot be converted into encoded data in a single operational process due to processing power limitations of the RIP 1050.

In the banding mode, the image bands may be satisfactorily converted using a LZW technique. In the page assembly mode, a template image, of say 16 megabytes, may be satisfactorily converted using a PB technique. However, the PB technique will often produce unsatisfactory results if used to convert the bands of the other of the multiple images. Accordingly, in the page assembly mode, these bands are converted using an LZW technique. Thus, in the page assembly mode, different compression techniques are utilized for a single image and perhaps even in a single job.

Accordingly, in the first embodiment of the present invention, the RIP 1050 is selectively operable in either the banding or the page assembly mode operation. Hence, in operation, the RIP 1050 initially scans the received image data representing the image, or image bands if the bands are sliced during pre-processing, to determine if banding mode or page assembly mode operations is required. If it is determined that banding mode operation is required, the RIP 1050 implements an LZW technique to convert the image data into encoded data. If, on the other hand, it is determined page assembly mode operation is required, the RIP 1050 further determines if the page image data represents a template image or banded image. If it is determined that the page image data represents a template image, the RIP 1050 implements a PB technique to convert the template image into encoded data. If, however, it is determined that the page image data represents a banded image, the RIP 1050 implements a LZW technique to convert the banded image data into encoded data. The selective operation of the RIP 1050, depending on the received image data facilitates the more efficient and effective processing of different types of large images than has been previously obtainable in conventional RIPs.

According to a second embodiment of the present invention, as a stream of sequential data is processed prior to encoding if, at the start of the sequence, the immediately preceding character, which is yet to be encoded, matches the next character in the stream and this next character is either solid black or solid white, and hence digitally represented in binary form by all 1's or 0's, encoding is interrupted. During the interruption, a determination is made as to whether the one or more characters, immediately following the next character in the sequence, also match the next character.

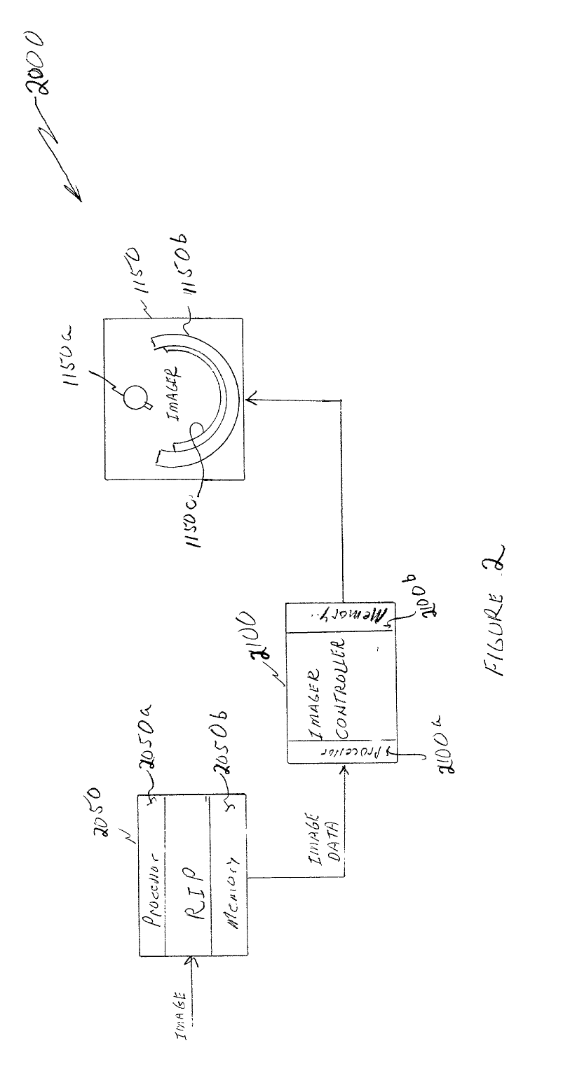

The second embodiment of the invention will now be described with reference to FIG. 2. As shown, FIG. 2 represents a somewhat simplified, exemplary depiction of an image processing system 2000. The system 2000 includes a raster image processor (RIP) 2050, which receives an image and converts the image into encoded data. The encoded data is then transmitted to imager controller 2100, which generates control signals to the imager 1150 in accordance with the encoded data received from the RIP 2050 to control the imager 1150 after decoding the received data. This imager 1150 is identical to the image 1150 of FIG. 1. More particularly, the control signals from the imager controller processor 2100a control the operation of the imager scanning assembly 1150a so as to form the image on a medium 1150c, which could be identical to the medium 1150c in FIG. 1. The medium 1150c is supported within the imager 1150 of FIG. 2. As shown, the imager 1150 includes a cylindrical drum 1150b for supporting the medium 1150c.

In the second embodiment of the present invention, the RIP processor 2050a implements a compression technique, which will hereafter be referred to as the AGFA compression technique. Using the AGFA compression technique, variable length of strings of byte based data can be processed. Processing using the AGFA technique will be substantially faster for many large image applications than the LZW compression techniques, while still providing satisfactory results for color images as well as those which are primarily black and white. Further, the AGFA technique is not limited to single bytes of data, and is therefore capable of compressing data on an arbitrary pixel or bit boundary basis. Additionally, the AGFA technique is capable of providing a higher compression rate than both PB and LZW compression techniques.

An exemplary representation of a stream of sequential input data as it would appear entering a RIP processor 2050a prior to encoding could, for example, include the string of characters “abc0 . . . 01c01”. The string “0 . . . 0” is a large string of zero's, for example representing image information for 32 k pixels.

Using the AGFA technique, the encoding and decoding processors, i.e. the RIP processor 2050a and imager controller processor 2100a, must coordinate on the transmission and receipt of codes, similar to the coordination required by LZW techniques. However, as will be described further below, the AGFA technique uses a compression dictionary containing four pre-defined compression codes. The characters in the input string are scanned to determine if a scanned sub-string of characters match certain of these pre-defined compression codes. If so, the matching sub-string of characters is encoded with the applicable pre-defined compression code. If a sub-string of characters does not match a pre-existing code, new codes corresponding to the sub-strings are added to the dictionary.

Further, the AGFA technique provides a look-ahead function, in which to determine whether or not the sub-string is greater than a minimum number, preferably 6, bytes, and if so the sub-string is encoded with a new code, which includes any applicable pre-existing code, and the length of the code field. The length is the width of the pre-existing code, with this code forming the most significant bits and serving as a continuation indicator, and any new coding, with this coding forming the least significant bits. Like LZW techniques, sub-strings are initially defined by codes having 9 bits or digits, but may be increased to up to 12 bits to add new codes. Once the 12 bit limit is exceeded, the dictionary is reset and subsequent codes are again defined initially with 9 bits.

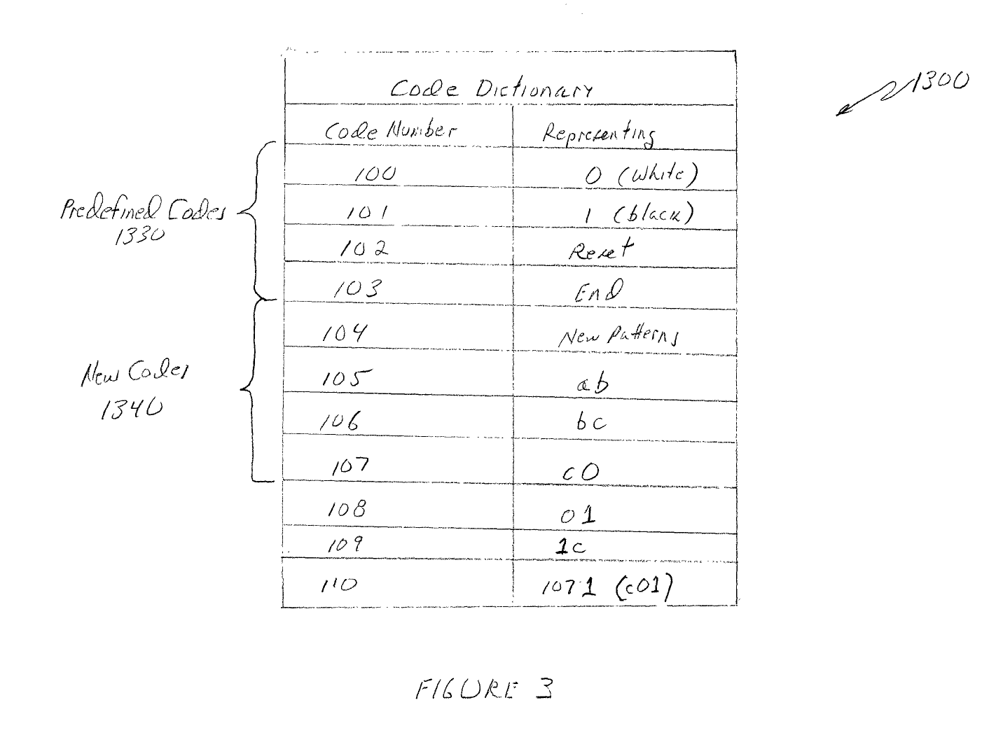

Referring to FIG. 3, in the AGFA technique, four codes are predefined and stored in the code dictionary 3000 on RIP memory 2050b as codes 1330. In the present example these codes are the code 100, representing a sub-string of all zero bytes which corresponds to white, code 101, representing a sub-string of all one bytes which corresponds to black, code 102, representing a reset, and the code 103, representing an end of the compressed encoded data. In the present example, codes 104, 105, and 106 etc. represent sub-strings of new patterns which are generated during the processing of the input date and also stored on RIP memory 2050b in code dictionary 3000. It will be recognized that because codes for the strings corresponding to white and black are paritally predefined, reduced processing is required to generate these codes, since the predefined codes can simply be read by RIP processor 2050a from the dictionary codes as required.

Using the AGFA technique, the RIP processor 2050a first sets a reset code 102 read from the code dictionary 3000 and reads the “a” in the sequence and the “b” immediately thereafter in the sequence. The RIP processor 2050a then determines from code dictionary 3000, if a code exists for the character sequence “ab”. Since, in this example, no such code exists at this point in the processing, a new code 105 is generated to represent the new pattern string “ab” and stored in the code dictionary 3000 on memory 2050b. The RIP processor 2050a continues by reading the “c” immediately following the “b” in the sequence. The RIP processor 2050b determines if a code exists for the character sequence “bc”. Since, in this example, no such code exist at this point in the processing, a new code 106 is generated to represent the new pattern string “bc” and stored in dictionary 3000.

The RIP 2050 continues by reading the “0” immediately following the “c” in the sequence. The RIP processor 2050a determines if a code exists for the character sequence “c0”. Since, in this example, no such code exists at this point in the processing, a new code 107 is generated to represent the new pattern string “c0” and stored in dictionary 3000. Also, because the “0” is recognized as special, the RIP processor 2050a, automatically scans ahead to read the next character in the sequence to determine if it matches with the initial “0” in the sequence. If not, the scanning ahead is immediately discontinued and the RIP processor 2050a proceeds with normal processing. If so, the scanning ahead continues on a character by character basis until no match with “0” is found, at which point the scanning ahead is discontinued and normal processing continues.

In this exemplary application of the AGFA technique, the RIP processor 2050a scans ahead and counts the number of “0” or “1” bytes in the sequence. Preferably, a compression threshold is pre-established and stored on the RIP memory 2050b. For example, the threshold might correspond to a 4 to 1 compression rate. If such a threshold is utilized and the number of “0” or “1” bytes counted is less than the number required to meet or exceed the threshold, e.g. if the sequence consist of only one or two zeros or ones, then a new code would be established for the sequence in the normal manner. Only if the number of “0” or “1” bytes counted meets or exceeds the threshold, is the sequence encoded using the applicable pre-defined code 100 or 101.

Assuming in the present example that the number of “0” bytes counted by the RIP processor 2050a meets or exceeds the threshold, the count is determined to be a repeat count. Either 9, 10, 11, or 12 bits can be used to code the repeat count. However, if the count is so great that more 11 bits would be required for the encoding, a continue code which may be generated by processor 2050a or retrieved from memory 2050b, is inserted as the least significant bit in the output code to enable the output codes representing the entire sequence of zeros or ones to be strung together. Accordingly, no matter how long the sequence, the low or less significant bit of each output code within the string of output codes would represent an end or continuation of the coding. Hence, 1 bit is sacrificed for the end/continuation bit leaving 8, 9, 10, or 11 bits for the repeat count.

Accordingly, in the present example the output code for the repeat count of “0” characters would be formed with the code “100” to indicate that this is a sequence of “0” characters, followed by “102” representing a first portion of the repeat count, and “001” indicating that the output codes for the repeat count continues. Thus, the first code in the string of repeat count output codes would be “100102001”. The second code in the string of repeat count output codes could be “102001”, with the “102” representing a second portion of the repeat count, and “001” indicating that the output codes for the repeat count continues. The last code in the string of repeat count output codes could be “0201”. The high bit of the last output code “0201” is made clear to indicate that this is the end of the repeat count information in this field.

Using the repeat count multiple output codes, the strung together codes for the entire repeat count would, in the above example be “1001020011020010201”. Thus, the strung together multiple bytes of output codes provide a full representation of the repeat count. In practice, five output codes may be used to represent up to four billion characters. Notwithstanding the number of bits in the output codes, the high bit is used to represent the count. Accordingly, whatever output code size is used, full advantage is taken of all available bits for the repeat count.

It is perhaps worthwhile emphasizing here that conventional LZW techniques lack the ability to scan ahead. Conventional PB techniques, on the other hand, scan ahead to locate matches with whatever character has been read and must fully generate the match coding for each matching sequence. In contrast, the present invention scans ahead to locate matches with only selective characters, preferably only white and black, respectively represented herein by “0” and “1”. Further, the present invention uses a predefined code for each of the selected characters, e.g. white and black, and hence the match coding for each matching sequence need only be partially generated, since the predefined code, e.g. codes 100 or 101, which identifies the applicable sequence as a sequence of white or black characters is pre-generated and need only be read from the code dictionary 3000. Accordingly, the present invention is capable of providing superior encoding of, for example, large images using less computing resources and computing time.

As noted above, once the RIP processor 2050a determines it is at the last “0” in the sequence, i.e. by determining from the scanning ahead on a character by character basis that a next character does not match with “0”, the scanning ahead is discontinued and normal processing continues. Thus, the RIP processor 2050a continues by reading the “1” immediately following the last “0” in the sequence. The processor 2050a determines if a code exists for the character sequence “01”. Since, in this example, no such code exist at this point in the processing, a new code 108 is generated to represent the new pattern string “Ol”. The processor 2050a proceeds by reading the “c” immediately following the “1” in the sequence. The processor determines if a code exists for the character sequence “1c”. Since, in this example, no such code exists at this point in the processing, a new code 109 is generated to represent the new pattern string “1c”.

The processor further proceeds by reading the “0” immediately following the second “c” in the sequence. The processor 2050a determines if a code exists for the character sequence “c0”. In this example, such a code, i.e. code 107, does exist. The RIP processor 2050a also scans ahead to determine if another “0” immediately follows this occurrence of “c0”. Since, in this case the RIP processor 2050a determination is negative, the scanning ahead is discontinued and normal processing continues.

The processor 2050a now proceeds by reading the “1” immediately following the second “c0” in the sequence. The processor 2050a determines if a code exists for the character sequence “c01”. Since, in this example, such a code does not exist, a new code 110 is generated to represent the new pattern string “c01” which can be represented as “1071”. The RIP processor 2050a also scans ahead to determine if another “1” immediately follows this occurrence of “c01”. Since, in this case the RIP processor 2050a determination is negative, the scanning ahead is discontinued and normal processing would continue if further characters remained to be encoded. However, since the “c01” are the final characters, encoding ends.

The processor ultimately generates encoded output data forming a sequence including the string of characters “102abc10010200110200102011071103”.

Similar to LZW techniques, in the AGFA technique, the RIP processor 2050a builds a tree of numerous codes generated using pre-defined or other codes and thereby is capable of providing satisfactory results even though the processing is performed on a byte by byte basis to find repeating bytes. However, as compared to LZW techniques, in the AGFA technique, processing time and resources required by the RIP 2050 to encode large sequences is substantially reduced through the use of special pre-defined codes. The decoding processor, i.e. the imager control processor 2100a, which could serve as a printer controller (not shown) or be some other type decoding device, builds a similar tree using the codes in the code dictionary received from the encoding processor, i.e. the RIP processor 2050a. Basically, the decoding processor performs the reciprocal of the encoding process to decode the encoded sequence characters “102abc10010200110200102011071103”. It should be understood that the encoded data could if desired be transmitted to the decoding device via a direct communications link, a local network, a public network such as the Internet, or some other type of network. Further, such communications may be by wire communications or wireless communications. It will also be recognized by those skilled in the art that, while the invention has been described above in terms of one or more preferred embodiments, it is not limited thereto. Various features and aspects of the above described invention may be used individually or jointly. Further, although the invention has been described in the context of its implementation in a particular environment and for particular purposes, e.g. imaging, those skilled in the art will recognize that its usefulness is not limited thereto and that the present invention can be beneficially utilized in any number of environments and implementations. Accordingly, the claims set forth below should be construed in view of the full breath and spirit of the invention as disclosed herein.

I/we claim:

1. An encoder for compressing image information comprising:
a memory configured to store a sequence of characters representing an image; and
a processor configured to determine if the stored sequence of characters corresponds to one of a banded image and a page image, to operate in a first mode to encode the stored sequence of characters if the sequence of characters is determined to correspond to the banded image, and to operate in a second mode, different than the first mode, to encode the stored sequence of characters if the first sequence of characters is determined to correspond to the page image.

2. An encoder according to claim 1, wherein the processor is further configured to encode the stored first sequence of characters in accordance with a pack-bit compression technique in the first mode of operation and in accordance with a LZW compression technique in the second mode of operation.

3. An encoder according to claim 2, wherein:
the processor is further configured to encode the stored first sequence of characters in accordance with a pack-bit compression technique in the second mode of operation.

4. An encoder according to claim 1, wherein:
if the first sequence of characters is determined to correspond to the page image, the processor is further configured to determine if the stored first sequence of characters corresponds to one of a primarily white page image and a primarily black page image, and, if so, to encode the stored first sequence of characters in accordance with a first compression technique while operating in the second mode of operation, and, if not, to encode the stored first sequence of characters in accordance with a second compression technique, different than the first compression technique, while operating in the second mode of operation.

5. An encoder according to claim 4, wherein the first compression technique is a pack-bit technique and the second compression technique is a LZW technique.

6. A method for compressing image information comprising:
receiving image data representing an image;
determining if the received image data corresponds to one of banded image data and page image data;
encoding the received image data in accordance with a first encoding technique, if the received image data is determined to correspond to the banded image data; and
encoding the received image data in accordance with a second encoding technique, different than the first encoding technique, if the received image data is determined to correspond to the page image data.

7. A method according to claim 6, wherein the first encoding technique is a pack-bit compression technique and the second encoding technique is a LZW compression technique.

8. A method according to claim 7, further comprising:
encoding the received image data in accordance with the first encoding technique, if the received image data is determined to correspond to the page image data.

9. A method according to claim 6, wherein the image data is determined to correspond to page image data, and further comprising:
determining if the received image data corresponds to one of primarily white page image data and primarily black page image data;
encoding the received image data in accordance with the first encoding technique, if the received image data is determined to correspond to the one of the primarily white and the primarily black page image data; and
encoding the received image data in accordance with the second encoding technique, if the received image data is determined not to correspond to the one of the primarily white and the primarily black page image data.

10. A method according to claim 9, wherein the first encoding technique is a pack-bit technique and the second encoding technique is an LZW technique.

11. An imaging system comprising:
a raster image processor configured to determine if a sequence of characters corresponds to one of a banded image and a page image, to operate in a first mode to encode the sequence of characters if the sequence of characters is determined to correspond to the banded image, and to operate in a second mode, different than the first mode, to encode the sequence of characters if the sequence of characters is determined to correspond to the page image; and
an imager controller configured to receive the encoded sequence of characters, and to operate in a first mode to decode the received encoded sequence of characters into the sequence of characters if the encoded sequence of characters is determined to correspond to the banded image, and to operate in a second mode to decode the received encoded sequence of characters into the sequence of characters if the encoded sequence of characters is determined to correspond to the page image.

12. A system according to claim 10, wherein the raster image processor is further configured to encode the sequence of characters in accordance with a pack-bit compression technique in the first mode of operation and in accordance with a LZW compression technique in the second mode of operation.

13. A system according to claim 12, wherein:
the raster image processor is further configured to encode the sequence of characters in accordance with a pack-bit compression technique in the second mode of operation.

14. A system according to claim 11, wherein:
if the first sequence of characters is determined to correspond to the page image, the raster image processor is further configured to determine if the sequence of characters corresponds to one of a primarily white page image and a primarily black page image, and, if so, to encode the sequence of characters in accordance with a first compression technique while operating in the second mode of operation, and, if not, to encode the sequence of characters in accordance with a second compression technique, different than the first compression technique, while operating in the second mode of operation.

15. A system according to claim 14, wherein the first compression technique is a pack-bit technique and the second compression technique is a LZW technique.
